(19) United States
(12) Patent Application Publication
(10) Pub. No.: US 2009/0269253 A1
(43) Pub. Date: Oct. 29, 2009

(54) HYDROGEN SULFIDE PRODUCTION-SUPPRESSING MEMBER AND EXHAUST GAS-PURIFYING CATALYST

(76) Inventor: Ichiro Hachisuka, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/159,995

(22) PCT Filed: Jan. 10, 2007
(86) PCT No.: PCT/JP2007/050548

§ 371 Date: Jul. 3, 2008

(30) Foreign Application Priority Data
Jan. 10, 2006 (JP) 2006-002714

(51) Int. Cl. B01D 53/48

(52) U.S. Cl. 422/169

(57) ABSTRACT

Disclosed herein is a hydrogen sulfide production-suppressing member, comprising: a sulfur-adsorbing portion 2 comprising an oxide comprising at least ceria, the sulfur-adsorbing portion 2 being disposed upstream side of an exhaust gas; and a sulfur-releasing portion 3 being disposed downstream side of the sulfur-adsorbing portion 2 and having surface acidity higher than that of the sulfur-adsorbing portion 2. SOₓ adsorbed on the sulfur-adsorbing portion is released in a high-temperature zone, but the released SOₓ, is difficult to adsorb on the sulfur-releasing portion 3, and thus is not adsorbed again. Thus, the production of H₂S is suppressed without using environmental loading substances such as nickel.

### BACKGROUND OF THE INVENTION

1. Field of the Invention

The present invention relates to a member for suppressing the production of hydrogen sulfide (hereinafter, referred to as “H₂S”) in exhaust gas from vehicle or the like, and an exhaust gas-purifying catalyst using the H₂S production-suppressing member. The H₂S production-suppressing member according to the present invention can suppress the production of H₂S at the time of engine idling after a high-speed running. The H₂S production-suppressing member of the present invention can be used by itself and can also be used as an exhaust gas-purifying catalyst such as a three-way catalyst.

2. Description of the Prior Art

As catalysts for purifying HC, CO and NOₓ, in vehicle exhaust gases, three-way catalysts have been widely used. Such three-way catalysts are formed by supporting platinum-group metals, such as Pt and Rh, on porous oxide supports, such as alumina, ceria, zirconia, and ceria-zirconia. Also, the three-way catalysts oxidize and purify HC and CO, and at the same time, reduce and purify NOₓ. Because these catalytic reactions efficiently proceed in an atmosphere in which oxidizing components and reducing components are mostly present in equivalent amounts, the combustion of fuel in vehicle engines provided with the three-way catalysts is controlled such that it occurs at around the theoretical air-fuel ratio (stoichiometric) (A/F=about 14.6±0.2).

However, the three-way catalysts have a problem in that, if an exhaust gas atmosphere is directed toward to reduction, sulfur oxide in exhaust gas will be reduced to H₂S, which is then emitted into the air. For example, ceria, having a function of adsorbing and releasing oxygen, comprises components essential in the three-way catalyst. However, in a vehicle engine provided with a three-way catalyst including ceria, there is a problem in that H₂S is produced when an exhaust gas atmosphere is rich (reducing atmosphere), which occurs, for example, in an acceleration mode.

The mechanism of H₂S production using ceria will now be explained. SO₂ in exhaust gas is oxidized to SOₓ by a metal catalyst. Ceria readily adsorbs SOₓ, because it is an oxide having a relatively high basicity. It is believed that the adsorbed SOₓ is slowly concentrated on the catalyst support, and is reduced to H₂S in a reducing atmosphere. Even a trace amount of H₂S is sensed by the human nose, giving an unpleasant feeling, and thus the emission needs to be suppressed. In addition, γ-alumina, which is widely used as a catalyst support, also readily adsorbs SOₓ.

Herein, the use of Ni or Cu oxide as the component of the three-way catalyst can be considered. The Ni or Cu oxide can suppress the production of H₂S, because it converts SO₂ into SO₃ or SO₄ in an oxidizing atmosphere and stores sulfur components as sulfides, for example, Ni₂S₃, in a reducing atmosphere.

Japanese Patent Application Publication No. H 08-015554, for example, discloses an exhaust gas-purifying catalyst formed by supporting a noble metal on a support, which comprises a composite oxide of nickel-barium, alumina and ceria. The support captures sulfur oxides as sulfates by alumina and ceria in a lean atmosphere, and captures H₂S by the composite oxide of nickel-barium in a reducing atmosphere. Thus, it can suppress the production of H₂S.

Furthermore, Japanese Patent Publication No. 2000-515419 or Japanese Patent No. 02598817 discloses the suppressing the production of H₂S using, as a support, a mixture of a ceria with NiO, Fe₂O₃ and the like. Also, Japanese Patent Application Publication No. H 07-194978 discloses the suppressing the production of H₂S using a support comprising Ni and Ca, supported on ceria.

However, Ni or Cu is limitedly used for vehicle exhaust gas-purifying catalysts because it is an environmental loading substance. There is another problem that the inherent purification properties thereof will be deteriorated when barium, for example, is added to a three-way catalyst.

In addition, Japanese Patent Application Publication No. H 02-020561 discloses bismuth-containing catalysts capable of oxidizing and removing H₂S. However, because these catalysts oxidize H₂S in an oxidizing atmosphere, they cannot prevent the emission of H₂S in a stoichiometric or reducing atmosphere.

### SUMMARY OF THE INVENTION

The present invention has been made to solve the above-described problems occurring in the prior art, and it is an object of the present invention to suppress the production of H₂S without using environmental loading substances such as nickel.

To achieve the above object, in one aspect, the present invention provides a member for suppressing the production of H₂S, comprising: a sulfur-adsorbing portion comprising an oxide including at least ceria, and disposed upstream side of an exhaust gas; and a sulfur-releasing portion having surface acidity higher than that of the sulfur-adsorbing portion and being disposed downstream side of the sulfur-adsorbing portion.

In another aspect, the present invention provides a exhaust gas-purifying catalyst comprising a hydrogen sulfide production-suppressing member and a noble metal supported thereon.

### BRIEF DESCRIPTION OF THE DRAWINGS

The above and other objects and features of the present invention will become apparent from the following description of preferred embodiment, given in conjunction with the accompanying drawings, in which:

FIG. 1 is a schematic cross-portional view of a three-way catalyst according to a first embodiment of the present invention;

FIG. 2 is a schematic cross-portional view of a three-way catalyst according to a second embodiment of the present invention;

FIG. 3 is a schematic cross-portional view of a three-way catalyst according to a fourth embodiment of the present invention; and

FIG. 4 is a graphic diagram showing the H₂S emission of each of examples, expressed as a value relative to the H₂S emission of comparative example being taken as 100.

### DETAILED DESCRIPTION OF THE PREFERRED EMBODIMENTS

Various embodiments of the present invention will now be described in detail with reference to the accompanying drawings.

A H₂S production-suppressing member according to the present invention comprises a sulfur-adsorbing portion and a sulfur-releasing portion. The sulfur-adsorbing portion comprises an oxide including at least ceria. For example, the sulfur-adsorbing portion can comprises a mixture of ceria powder with other oxide powders such as alumina powder, and can also comprises either ceria alone or an composite oxide alone comprising ceria. Examples of the composite oxide comprising ceria may include ceria-zirconia, alumina-ceria-zirconia and so on.

As the ceria of the sulfur-adsorbing portion, it is preferable to use ceria having a specific surface area of less than 5 m²/g . In this case, the oxygen adsorption and release properties of ceria are maintained while the SOₓ adsorption properties thereof are decreased. Thus, the degree of rich can be reduced, and at the same time, SOₓ can be released before it is reduced to H₂S, and the production of H₂S can be suppressed. Similarly, when the sulfur-adsorbing portion contains alumina, it is preferable to use θ-alumina having a specific surface area smaller than that of γ-alumina.

The sulfur-releasing portion has acidity higher than that of the sulfur-adsorbing portion. The acidity of the sulfur-releasing portion can be increased using a method of applying an oxide having acidity higher than that of ceria in the sulfur-adsorbing portion, or a method of increasing the basicity of the sulfur-adsorbing portion. Examples of oxides having acidity higher than ceria may include silica, silica-alumina composite oxide, zirconia-containing alumina, titania, titania-zirconia composite oxide and so on, and one or more selected from these oxides can be used in the present invention. Among them, it is preferable to use titania, onto which SOₓ is difficult to be adsorbed, because titania has high acidity. Also, although alumina or zirconia has relatively low acidity, it can be advantageously used in the present invention because the acidity thereof will be increased when it is coated with titania.

To increase the basicity of the sulfur-adsorbing portion, at least one selected from among, for example, alkaline earth metals and rare earth elements is supported on the sulfur-adsorbing portion. As a result, the basicity of the sulfur-adsorbing portion is increased, leading to an increase in its ability to adsorb SOₓ. Thus, the emission of SOₓ, for example, at the time of engine idling after a high-speed running, can be suppressed, so that the production of H₂S can be suppressed. The supporting amount of said at least one selected from alkaline earth metals and rare earth elements is preferably in the range of 0.01˜0.5 mol per liter of the H₂S production-suppressing member. At less than 0.01 mol, the effect of the supported metal or element will not be expressed. On the other hand, if the metal or element is supported in an amount of more than 0.5 mol, the effect thereof will be saturated, and at the same time, when a noble metal is supported on the sulfur-adsorbing portion, the activity of the noble metal will be reduced.

The sulfur-adsorbing portion is disposed upstream side of an exhaust gas, and the sulfur-releasing portion is disposed downstream side of the sulfur-adsorbing portion. For example, a pellet-shaped sulfur-adsorbing portion can be filled in an exhaust pipe upstream side of an exhaust gas, and a pellet-shaped sulfur-releasing portion can be provided downstream side of the sulfur-adsorbing portion. Alternatively, a honeycomb-shaped sulfur-adsorbing portion having a coating layer comprising, for example, ceria, formed on a honeycomb substrate, may be disposed upstream side of the exhaust gas, and a honeycomb-shaped sulfur-releasing portion having a coating layer comprising, for example, titania, formed on a honeycomb substrate, may be disposed downstream side of the sulfur-adsorbing portion. A coating layer comprising the sulfur-adsorbing portion may be formed on one honeycomb substrate upstream side of the exhaust gas, and a coating layer comprising the sulfur-releasing portion may be formed on the honeycomb substrate downstream side of the sulfur-adsorbing portion.

For example, in the case of an H₂S production-suppressing member, in which a coating layer comprising the sulfur-adsorbing portion is formed on one honeycomb substrate on the upstream side of the exhaust gas, and a coating layer comprising the sulfur-releasing portion is formed on the honeycomb substrate on the downstream side of the sulfur-adsorbing portion, the sulfur-adsorbing layer containing the sulfur-adsorbing portion can be formed in a range of ¼-⅔ of the total length of the H₂S production-suppressing member. If the length of the sulfur-adsorbing layer is less than ¼ of the total length of the H₂S production-suppressing member, the oxygen adsorption and release functions of ceria will be excessively decreased, making it difficult to relieve a rich atmosphere and suppress the production of H₂S. If the area of the sulfur-adsorbing layer is more than ⅔ of the total area of H₂S production-suppressing member, on the other hand, the adsorption range of SOₓ will be increased, and at the same time, released SOₓ will be adsorbed again, making it difficult to suppress the production of H₂S.

The H₂S production-suppressing member according to the present invention can be supported with a noble metals such as Pt, Rh, Pd, Ir, or Ru, and thus can be used as an exhaust gas-purifying catalyst for suppressing the production of H₂S, and preferably a three-way catalyst. Also, the supporting of the noble metal on the H₂S production-suppressing member improves the H₂S-suppressing performance of the member. The noble metal is preferably supported on at least the sulfur-adsorbing portion. When the noble metal is supported on the sulfur-adsorbing portion, the oxygen adsorption and release functions of ceria can be improved to reduce fluctuations in the atmosphere of exhaust gas. Thus, it will be easy to maintain the exhaust gas atmosphere at an approximately stoichiometric ratio, and a high activity of the three-way catalyst will be expressed.

However, when only the sulfur-adsorbing portion is supported with a necessary amount of the noble metal, the supporting density of the metal will be increased, so that deterioration such as grain growth will tend to occur during the use of the catalyst. For this reason, it is preferable to support the noble metal uniformly on both the sulfur-adsorbing portion and the sulfur-releasing portion.

The supporting amount of the noble metal is preferably 0.05-10 wt %. If the supporting amount is less than 0.05 wt %, the catalyst will not be practical as an exhaust gas-purifying catalyst, and if the noble metal is supported in an amount of more than 10 wt %, the effect thereof will be saturated, and at the same time, the preparation coat of the catalyst will be increased.

In the prior ceria-containing three-way catalyst, ceria is present throughout an exhaust gas, and thus SOₓ is adsorbed almost uniformly through the exhaust gas. However, in the H₂S production-suppressing member according to the present invention, the sulfur-adsorbing portion comprising basic ceria is disposed upstream side of the exhaust gas, and the sulfur-releasing portion having surface acidity higher than that of the sulfur-adsorbing portion is disposed downstream side of the sulfur-adsorbing portion. Thus, SOₓ in exhaust gas is adsorbed on the sulfur-adsorbing portion on the upstream side, but is difficult to be adsorbed on the sulfur-releasing portion. In other words, according to the H₂S production-suppressing member of the present invention, the adsorption range of SOₓ is narrower than that in the prior art, and thus the production of H₂S is decreased.

Also, in the H₂S production-suppressing member of the present invention, SOₓ adsorbed on the sulfur-adsorbing portion is released at a high temperature zone, but the released SOₓ is difficult to adsorb on the sulfur-releasing portion. Thus, the released SOₓ is prevented from being adsorbed again to produce H₂S therefrom.

Moreover, in the sulfur-adsorbing portion, the degree of a rich atmosphere is reduced due to the oxygen adsorption and release properties of ceria, and exhaust gas having reduced richness is brought into contact with the sulfur-releasing portion. Thus, H₂S becomes more difficult to produce in the sulfur-releasing portion. In addition, the exhaust gas-purifying catalyst supported with the noble metal is used, the oxygen adsorption and release functions of ceria can be further increased, and thus the production of H₂S can be further suppressed.

As a result, the H₂S production-suppressing member and exhaust gas-purifying catalyst of the present invention can effectively suppress the production and emission of H₂S through the synergistic action thereof.

### EXAMPLES

Hereinafter, the present invention will be described in further detail with reference to Examples and Comparative Examples. Like reference numerals denote like element even in different drawings.

### Example 1

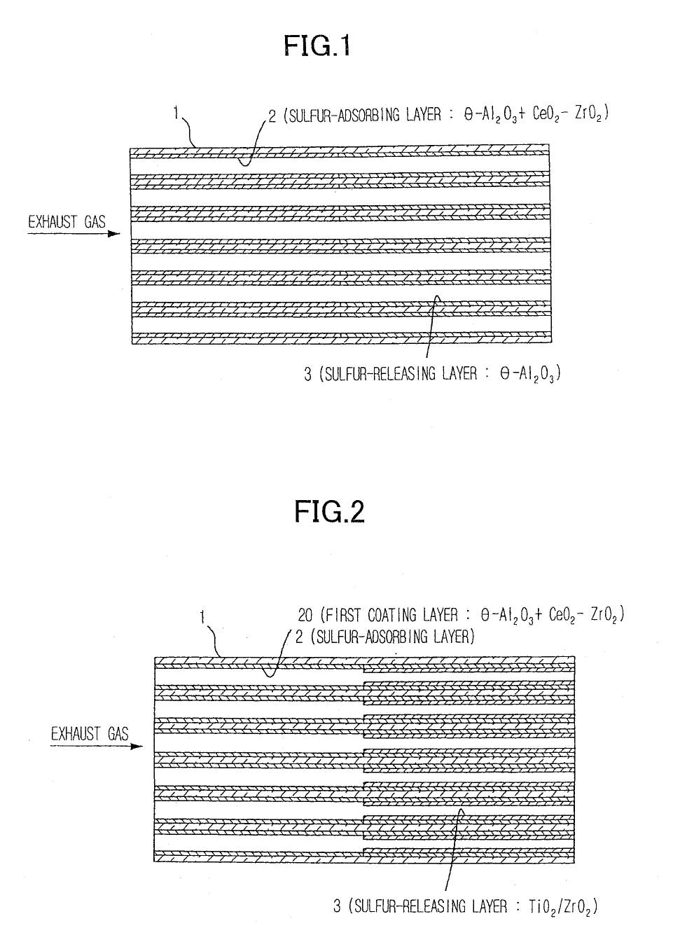

FIG. 1 shows a three-way catalyst of this Example. This three-way catalyst comprises a cordierite honeycomb substrate 1, a sulfur-adsorbing layer 2 formed on one side of half of the honeycomb substrate from the upstream side of an exhaust gas and a sulfur-releasing layer 3 formed on one side of the remaining half of the honeycomb substrate 1 from the downstream side of the exhaust gas. The sulfur-adsorbing layer 2 contains a ceria-zirconia solid solution, but the sulfur-releasing layer 3 contains no ceria-zirconia solid solution. Hereinafter, a method of preparing this three-way catalyst will be described.

The cordierite honeycomb substrate 1 (1.1-L volume, 103-mm diameter, 130-mm length, 400 cpsi cell density and 100-μm wall thickness) was prepared. A range of ½ of the length of the honeycomb substrate 1 from one end of the honeycomb substrate (i.e., a range of half of the length of the substrate from the upstream side of an exhaust gas) was wash-coated with a slurry containing, as main components, 90 parts by weight of θ-alumina powder (100 m²/g specific surface area) and 100 parts by weight of ceria-zirconia solid solution powder (CeO₂:ZrO₂=1:1 molar ratio and 85 m²/g specific surface area). Then, the coated slurry was dried at 120° C., and calcined at 650° C. for 3 hours, thus forming the sulfur-adsorbing layer 2. The sulfur-adsorbing layer 2 was formed in an amount of 190 g per liter of the honeycomb substrate 1.

Then, the surface of the honeycomb substrate, on which the sulfur-adsorbing layer 2 has not been formed, was wash-coated with a slurry containing θ-alumina powder as a main component, and the coated slurry was dried at 120° C., followed by calcining at 650° C. for 3 hours, thus forming the sulfur-releasing layer 3. The sulfur-releasing layer 3 was formed in an amount of 90 g per liter of the honeycomb substrate 1.

The honeycomb substrate 1 having the sulfur-adsorbing layer 2 and the sulfur-releasing layer 3 was immersed in an aqueous rhodium nitrate solution so that it was adsorbed and supported with rhodium. Then, the substrate 1 was taken out of the solution and is dried at 120° C., followed by calcining at 500° C. for 1 hour, so that Rh was supported uniformly throughout the substrate 1. Also, the honeycomb substrate was impregnation in a given amount of a given concentration of dinitrodiamine platinum solution so that it was adsorbed and supported with platinum. Then, the substrate was dried at 120° C., followed by calcining at 500° C. for 1 hour, so that Pt was supported uniformly throughput the substrate 1. Pt and Rh were supported in amounts of 1.0 g and 0.2 g, respectively, per liter of the honeycomb substrate 1.

### Example 2

FIG. 2 shows a three-way catalyst of Example 2 of the present invention. This three-way catalyst comprises a cordierite honeycomb substrate 1, a first coating layer 20 formed throughout the honeycomb substrate 1, and a sulfur-releasing layer 3 formed on the surface of the first coating layer 20 in a range of the downstream side corresponding to half of the length of the honeycomb substrate 1. The first coating layer 20 contains a ceria-zirconia solid solution, but the sulfur-releasing layer 3 contains no ceria-zirconia solid solution. The surface acidity of the sulfur-releasing layer 3 is higher than that of the first coating layer. Specifically, the first coating layer 20 exposed over the upstream-side range corresponding to half of the length of the honeycomb substrate 1 constitutes the sulfur-adsorbing layer 2. Hereinafter, a method of preparing this three-way catalyst will be described.

The same honeycomb substrate 1 as in Example 1 was used, and the same slurry containing θ-alumina powder (the same as in Example 1) and ceria-zirconia solid solution powder (the same as in Example 1) as main components, was wash-coated throughout the honeycomb substrate 1. Then, the coated slurry was dried at 120° C., followed by calcining at 650° C. for 3 hours, thus forming the first coating layer 20. The first coating layer 20 was formed in an amount of 190 g per liter of the honeycomb structure.

Then, the surface of the first coating layer 20 on the downstream side corresponding to half of the length of the honeycomb substrate 1 was wash-coated with a slurry containing, as main components, 90 parts by weight of θ-alumina (100 m²/g specific surface area) and 20 parts by weight of TiO₂-coated ZrO₂ powder (TiO₂:ZrO₂=30:70). Then, the coated slurry was dried at 120° C., followed by calcining 650° C. for 3 hours, thus forming the sulfur-releasing layer 3. The sulfur-releasing layer 3 was formed in an amount of 20 g per liter of the honeycomb substrate. Also, the honeycomb substrate was supported with Pt and Rh in the same manner as in Example 1.

### Example 3

This Example is the same as Example 1, except for the composition of the sulfur-releasing layer 3. Hereinafter, a method of preparing the three-way catalyst of Example 3 will be described.

The same honeycomb substrate as in Example 1 was used, and the same sulfur-adsorbing layer 2 as in Example 1 was formed over the range of ½ of the length of the honeycomb substrate from one end of the substrate.

Then, a slurry containing, as main components, 90 parts by weight of θ-alumina powder (specific surface area of 100 m²/g) and 20 parts by weight of TiO₂-coated ZrO₂ powder (TiO₂:ZrO₂=30:70), was wash-coated in a range of the half length of the honeycomb substrate from the downstream-side end. Then, the coated slurry was dried at 120° C., followed by calcining at 650° C. for 3 hours, thus forming the sulfur-releasing layer 3. The sulfur-releasing layer 3 was formed in an amount of 110 g per liter of the honeycomb substrate 1. In addition, the honeycomb substrate 1 was supported with Pt and Rh in the same manner as in Example 1.

### Example 4

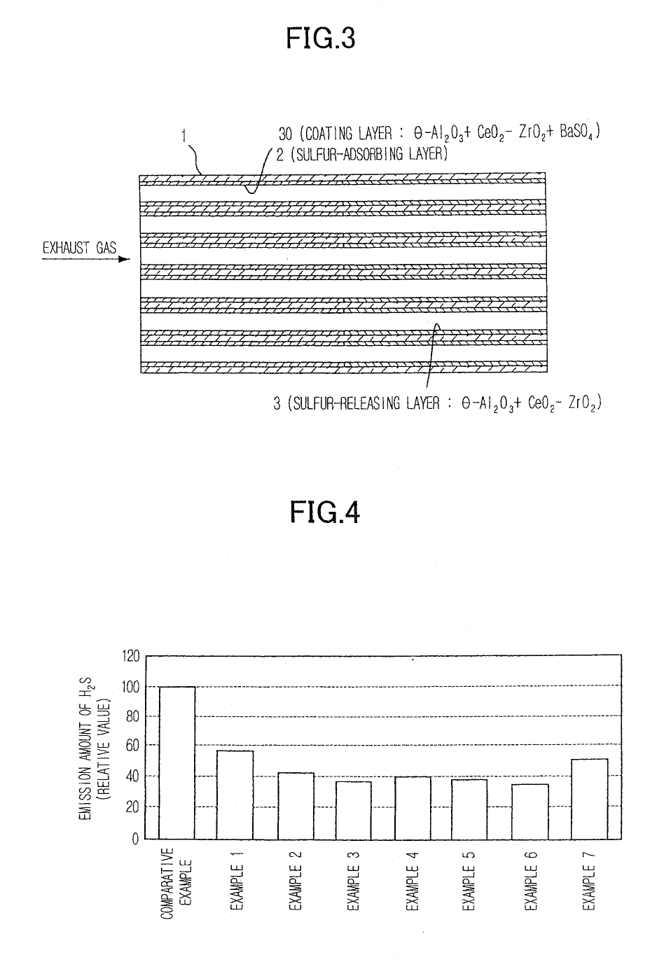

FIG. 3 shows a three-way catalyst according to Example 4. This three-way catalyst comprises a cordierite honeycomb substrate 1 and a coating layer 30 formed throughout the honeycomb substrate 1. The coating layer 30 in the upstream-side range corresponding to the half length of the honeycomb substrate is supported with Ba. Thus, the surface acidity of the coating layer is higher in the downstream-side range corresponding to the half length of the substrate than in the upstream-side range corresponding to the half length of the substrate. The sulfur-adsorbing layer 2 is formed on a half length of the upstream side, and the sulfur-releasing layer 3 is formed on a half length of the downstream side. Hereinafter, a method of preparing this three-way catalyst will be described.

The same honeycomb substrate 1 as in Example 1 was prepared. The range of the half length of the honeycomb substrate 1 from one end thereof was wash-coated with a slurry containing, as main components, 90 parts by weight of θ-alumina powder (the same as in Example 1), 100 parts by weight of ceria-zirconia solid solution powder (the same as in Example 1) and a given amount of barium sulfate powder. Then, the coated slurry was dried at 120° C., followed by calcining at 650° C. for 3 hours, thus forming the sulfur-adsorbing layer 2. The sulfur-adsorbing layer 2 was formed in an amount of 190 g per liter of the honeycomb substrate 1. Ba was supported in an amount of 0.1 mol per liter of the honeycomb substrate 1.

Then, the range of the half length of the honeycomb substrate 1 from the downstream-side end was wash-coated with a slurry containing, as main components, 90 parts by weight of θ-alumina powder (the same as in Example 1) and 100 parts by weight of ceria-zirconia solid solution powder (the same as in Example 1). Then, the coated slurry was dried at 120° C., followed by calcining 650° C. for 3 hours, thus forming the sulfur-releasing layer 3. The sulfur-releasing layer 3 was formed in an amount of 190 g per liter of the honeycomb substrate 1. In addition, Pt and Rh were supported in the same manner as in Example 1.

### Example 5

In a same manner as in Example 4, a three-way catalyst according to Example 5 comprises a cordierite honeycomb substrate 1 and a coating layer 30 formed throughout the honeycomb substrate 1. The coating layer 30 on the upstream side corresponding to the half length of the honeycomb substrate is supported with La. La is supported in an amount of 0.1 mol per liter of the honeycomb substrate. Thus, the surface acidity of the coating layer 30 is higher on the downstream side corresponding to the half length of the honeycomb substrate 1 than on the upstream side. Also, the sulfur adsorbing layer 2 is formed on the upstream side corresponding to the half length of the substrate, and the sulfur-releasing layer 3 is formed on the downstream side corresponding to the half length of the substrate. The three-way catalyst of this Example was prepared in the same manner as in Example 4, except that lanthanum oxide powder was used instead of barium sulfate powder.

### Example 6

In the same manner as in Example 4, a three-way catalyst according to Example 6 comprises a cordierite honeycomb substrate 1 and a coating layer 30 formed throughout the honeycomb substrate 1. The coating layer 30 on the upstream side corresponding to the half length of the substrate is supported with Ba and La. Each of Ba and La is supported in an amount of 0.1 mol per liter of the honeycomb substrate 1. Thus, the surface acidity of the coating layer 30 is higher on the downstream side corresponding to the half length of the honeycomb substrate 1 than on the upstream side. Also, the sulfur adsorbing layer 2 is formed on the upstream side corresponding to the half length of the substrate, and the sulfur-releasing layer 3 is formed on the downstream side corresponding to the half length of the substrate. The three-way catalyst of this Example was prepared in the same manner as in Example 4, except that lanthanum oxide powder was used in addition to barium sulfate powder.

### Example 7

Example 7 is carried out in the same manner as in Example 1, except that the specific surface area of the ceria-zirconia solid solution contained in the sulfur-adsorbing layer is 3 m²/g.

### Comparative Example

A three-way catalyst of this Comparative Example comprises a cordierite honeycomb substrate 1 and a coating layer 30 formed throughout the honeycomb substrate 1, and the composition thereof is uniform throughout thereof. Hereinafter, a method of preparing this three-way catalyst will be described.

The same honeycomb substrate 1 as in Example 1 was used, and a slurry containing, as main components, 90 parts by weight of γ-alumina powder (specific surface area of 180 m²/g) and 100 parts by weight of ceria-zirconia solid solution powder (the same as in Example 1), was wash-coated throughout the honeycomb substrate 1. Then, the coated slurry was dried at 120° C., followed by calcining at 650° C. for 3 hours, thus forming a coating layer 21. The coating layer 21 was formed in an amount of 190 g per liter of the honeycomb substrate 1. In addition, Pt and Rh were supported in the same manner as in Example 1.

Test and Analysis

Table 1 below summarizes the oxide structure of each of the catalysts.

TABLE 1

| | Upstream half portion | Downstream half-portion |
|---|---|---|
| | (sulfur-adsorbing layer) | (sulfur-releasing layer) |
| Example 1 | θ-Al₂O₃, CeO₂—ZrO₂ | θ-Al₂O₃ |
| Example 2 | θ-Al₂O₃, CeO₂—ZrO₂ | θ-Al₂O₃, CeO₂—ZrO₂, |
| | | TiO₂/ZrO₂ |
| Example 3 | θ-Al₂O₃, CeO₂—ZrO₂ | θ-Al₂O₃, TiO₂/ZrO₂ |
| Example 4 | θ-Al₂O₃, CeO₂—ZrO₂, BaSO₄ | θ-Al₂O₃, CeO₂—ZrO₂ |
| Example 5 | θ-Al₂O₃, CeO₂—ZrO₂, La₂O₃ | θ-Al₂O₃, CeO₂—ZrO₂ |
| Example 6 | θ-Al₂O₃, CeO₂—ZrO₂, BaSO₄, | θ-Al₂O₃, CeO₂—ZrO₂ |
| | La₂O₃ | |
| Example 7 | θ-Al₂O₃, CeO₂—ZrO₂ (3 m²/g) | θ-Al₂O₃, |
| Comparative | γ-Al₂O₃, CeO₂—ZrO₂ | γ-Al₂O₃, CeO₂—ZrO₂ |
| Example 1 | | |

Each of the three-way catalysts was mounted in the exhaust system of an engine bench, controlled at a stoichiometric ratio. Then, the engine was run in the LA#4 mode, and accelerated to 80 km/hr in a full acceleration mode in which an accelerator pedal was strongly stepped on. Then, the operation mode was converted to an idling state. Just after conversion to the idling mode, the amount of H₂S emitted was measured, and the measurement results are shown in FIG. 4, in which the measurement value of each of Examples are expressed as a value relative to that of Comparative Example being taken as 100.

As shown in FIG. 4, it can be seen that the three-way catalyst of each of Example showed an H₂S emission lower than that of Comparative Example. This is because the sulfur-adsorbing layer 2 and the sulfur-releasing layer 3 were formed. Also, Example 3 showed a value lower than those of Examples 1 and 2, and Example 6 showed a value lower than those of Examples 4 and 5. This suggests that it is preferable that the difference in acidity between the sulfur-adsorbing layer 2 and the sulfur-releasing layer 3 be greater. In addition, Example 7 showed a value lower than that of Example 1, suggesting that it is preferable that the surface area of ceria contained in the sulfur-adsorbing layer 2 be smaller.

Also, H₂S production-suppressing members, in which Pt and Rh were eliminated from the three-way catalysts of Examples and Comparative Example, were tested in the same manner as described above. AS a result, the relative values of Examples to Comparative Example were equal to the values of the three-way catalysts shown in FIG. 4, except that all Examples and Comparative Example showed a slight increase in H₂S emissions.

While the invention has been shown and described with respect to the preferred embodiments, it will be understood by those skilled in the art that various changes and modification may be made without departing from the spirit and scope of the invention as defined in the following claims.

1. A hydrogen sulfide production-suppressing member, comprising:
a sulfur-adsorbing portion comprising an oxide including at least ceria, and being disposed upstream side of an exhaust gas; and
a sulfur-releasing portion having surface acidity higher than that of the sulfur-adsorbing portion, and being disposed downstream side of the sulfur-adsorbing portion.

2. The hydrogen sulfide production-suppressing member according to claim 1, wherein the sulfur-releasing portion comprises titania.

3. The hydrogen sulfide production-suppressing member according to claim 1, wherein the sulfur-adsorbing portion is supported with at least one selected from a group comprising alkaline earth metals and rare earth elements.

4. The hydrogen sulfide production-suppressing member according to claim 3, wherein said at least one selected from the group comprising alkaline earth metals and rare earth elements is supported in an amount of 0.01-0.5 mol per liter of hydrogen sulfide production-suppressing member.

5. The hydrogen sulfide production-suppressing member according to claim 1, wherein a coating layer comprising the sulfur-adsorbing portion is formed upstream side of an exhaust gas in an honeycomb substrate, a coating layer comprising the sulfur-releasing portion is formed downstream side thereof, and the coating layer comprising the sulfur-adsorbing portion formed in a range lengthened about ¼-⅔ of the total length of hydrogen sulfide production-suppressing member.

6. An exhaust gas-purifying catalyst comprising a hydrogen sulfide production-suppressing member, comprising:
a sulfur-adsorbing portion comprising an oxide including at least ceria, and being disposed upstream side of an exhaust gas; and
a sulfur-releasing portion having surface acidity higher than that of the sulfur-adsorbing portion, and being disposed downstream side of the sulfur-adsorbing portion, and
a noble metal supported on a hydrogen sulfide production-suppressing member.

7. The exhaust gas-purifying catalyst according to claim 6, wherein the noble metal is supported on at least said sulfur-adsorbing portion.

8. The exhaust gas-purifying catalyst according to claim 6, wherein the noble metal is supported uniformly on both the sulfur-adsorbing portion and the sulfur-releasing portion.
